(19) United States
(12) Patent Application Publication
(10) Pub. No.: US 2007/0099150 A1
(43) Pub. Date: May 3, 2007

(54) Dental drill device with a stop element

(75) Inventors: Daniele Muller, Binningen (CH); Frank Kenk, Weil am Rhein (DE)

Correspondence Address: RISSMAN JOBSE HENDRICKS & OLIVERIO, LLP, ONE STATE STREET, SUITE 800, BOSTON, MA, 02109, US

(73) Assignee: Straumann Holding AG, Basel (CH)

(21) Appl. No.: 11/514,462

(22) Filed: Sep. 1, 2006

(30) Foreign Application Priority Data
Sep. 5, 2005 (EP) 05 019 271.5

(51) Int. Cl. A61C 3/02

(52) U.S. Cl. 433/165

(57) ABSTRACT

Dental drill device (10) comprises a drill (12) with a stop element (28). In various embodiments, at one end, the drill (12) has a cutting part (14) with a free drill end (16) and, at the other end, it has a shank part (18). Arranged on the shank part (18) there is a holder portion (26) with several fastening recesses (30) spaced apart from one another in the axial direction (A), each fastening recess (30) being limited, in the direction of an exposed receiving end area (20) of the shank part (18), by an abutment surface (34) which is at right angles to the axial direction (A) of the drill (12). A stop element with a drill abutment (36) is fitted onto the holder portion (26) and has an engagement element (58). The engagement element (58) has a counter-abutment surface (35) which cooperates in a form fit with the abutment surface (32). By means of the form fit acting between the abutment surface (32) and the counter-abutment surface (35), the stop element (28) is held on the drill (12) such that it cannot be displaced in the direction of the receiving end area (20) of the drill (12).

### FIELD OF THE INVENTION

The present invention relates to a dental drill device.

### BACKGROUND OF THE INVENTION

U.S. Pat. No. 5,890,897 discloses a dental drill device with a stop element held on a drill. The stop element engages completely around the drill in the circumferential direction and is held on it so as to be displaceable in the axial direction.

The drill has an exposed drill end on a cutting part, and a cylinder shank with an exposed shank end face. Located between the drill end and the shank end face there is a holder portion with several spherical-cap-shaped fastening recesses spaced apart from one another in the axial direction and oriented toward one another.

The stop element has a circular-cylindrical shape with a drill abutment surface. In the axial direction, the stop element is designed with a central through-opening which corresponds substantially to a diameter of the drill. In the radial direction of the stop element, an insert opening runs through the stop element. A spring-loaded, pin-like engagement element is arranged in the insert opening.

The stop element can be fitted onto the drill from the direction of the drill end and can be fixed with a force fit on the drill by means of the engagement element engaging in one of the fastening recesses.

Consequently, the drill abutment surface is arranged at a defined and desired distance from the drill end, as a result of which a maximum drilling depth is defined. During drilling of a hole in a jawbone, the drill abutment surface bears on the jawbone or gum when the desired drilling depth is reached.

U.S. Pat. No. 5,890,897 also discloses an alternative embodiment of the stop element. In this embodiment, the engagement element is provided with an outer thread and is screwed into the insert opening. By orienting the engagement element with one of the fastening recesses and then turning the engagement element, the latter comes into form-fit engagement with the relevant fastening recess.

EP 0 643 567 B1 discloses a drill having annular markings arranged around the circumference and spaced apart from one another in the axial direction, these markings differing in color from the surface layer of the drill. During drilling, the annular markings are used to estimate the actual drilling depth. The rings are produced by surface treatment of the drill.

U.S. Pat. No. 5,941,706 discloses a drill which has colored rings extending in the circumferential direction and spaced apart from one another in the axial direction. For this purpose, the drill has annular grooves spaced apart from one another in the axial direction and filled with colored material. During drilling, the actual drilling depth can be read off with the aid of these colored rings.

U.S. Pat. No. 6,514,258 B1 discloses a dental drill device comprising a drill and a stop element. The drill has a drill end and a cylinder shank. At an end area of the cylinder shank directed toward the drill end, it has a cuff-like thickened area. This thickened area is limited in the direction of the drill end by a narrowing truncated cone surface. The stop element has a sleeve-shaped design and has a drill abutment surface at one of its end faces and, adjoining another end face, a clamp area which is intended to engage around the thickened area. The stop element can be pushed onto the drill from the direction of the drill end, by which means the clamp area is fitted onto the thickened area in the manner of a snap-fit closure. The stop elements are designed in different lengths corresponding to different drilling depths.

U.S. Pat. No. 6,739,872 B1 discloses a dental drill device composed of a drill and of a stop element engaging in the manner of a sleeve around the drill. The drill has a cutting part with an exposed drill end, and a cylinder shank. A holder portion is formed between the cutting part and the cylinder shank. The holder portion has a thread which is designed running in the opposite direction to the turn of the chip grooves of the twist drill. The stop element is first fitted with an inner thread onto the drill from the direction of the drill end and is screwed onto the thread. Toward the drill end, the stop element has an exposed drill abutment surface. In order to set a maximum drilling depth, the stop element is turned to the desired axial position. As soon as the drill abutment surface is stopped, during drilling, by interaction with a material into which the drill is being drilled, or as soon as it is prevented from turning together with the drill, the effect of the thread is that the drill is automatically moved out of the drilled hole.

The known dental drill devices and dental drills have different disadvantages. Those drills designed only with visual elements for determining the drilling depth have the disadvantage that, during use, the actual drilling depth cannot be defined with precision, and the visual markings can become soiled and thus unreadable.

In dental drill devices with a stop element, handling can prove to be complicated, for example in the one according to U.S. Pat. No. 6,514,258 B1, because the length of the stop element has to be adapted individually to the respective drilling depth of the hole that is to be drilled, and because a drill stop element, once it has been used, cannot be used again.

During the use of the dental drill device disclosed in U.S. Pat. No. 5,890,897, when the drill abutment surface of the stop element is resting on the jawbone or gum, the force-fit connection can be overcome, which would lead to a drilled hole that was too deep.

### SUMMARY OF THE INVENTION

In accordance with various embodiments of the present invention, a dental drill device is provided in which the position of the drill abutment surface relative to the drill, and thus the depth of the hole to be drilled, can be defined in a reliable and simple manner.

In one or more embodiments, all the elements of the dental drill device may be re-usable.

In one embodiment, a dental drill device has a drill and a stop element arranged thereon, the drill having, at one end, a cutting part with a front drill end and, at the other end, a shank part with a receiving end area which is intended to be received in a drill-holder device, the shank part having a holder portion for the stop element, and the stop element having a drill abutment surface which is exposed in the direction of the drill end and which is held on the drill at a desired distance from the drill end, wherein several fastening recesses spaced apart from one another in the axial direction (A) of the drill are arranged within the holder portion of the drill, and the stop element has an engagement element engagable in one of the fastening recesses, wherein the fastening recesses, on their side directed toward the receiving end area, are limited by an abutment surface extending at least approximately at right angles to the axial direction (A), and the engagement element has a counter-abutment surface which cooperates in a form fit with the relevant abutment surface.

In another embodiment, a dental drill device has a drill defining an axial direction (A), with an extension element, and with a stop element arranged on the latter, the drill having, at one end, a cutting part with a front drill end and being intended, at the other end, to be held on the extension element, the extension element having a receiving end area receivable in a drill holder device, and a holder portion for the stop element, and the stop element having a drill abutment surface which is exposed in the direction of the drill end and which is held on the extension element at a desired distance from the drill end, wherein several fastening recesses spaced apart from one another in the axial direction (A) of the extension element are arranged thereon within the holder portion, and the stop element has an engagement element engagable in one of the fastening recesses, said fastening recesses being limited, on their side directed toward the receiving end area, by an abutment surface extending at least approximately at right angles to the axial direction (A), and the engagement element having a counter-abutment surface which cooperates in a form fit with the relevant abutment surface.

In accordance with various embodiments, by means of the abutment surface being oriented at least approximately at right angles to the axis of the drill, and by means of the engagement element which has a counter-abutment surface cooperating with the abutment surface in a form-fit manner, it is ensured that, when a force acts on the stop element in the axial direction and away from the drill end, the stop element is held immovably on the drill or extension element.

In one embodiment, the stop element has a radially outward, circular-cylindrical guide surface. This makes it possible to guide the stop element, and therefore the drill, on a drill jig for example, by which means the position and direction of the hole that is to be drilled can be defined with precision.

In another embodiment, the dental drill device comprises a drill jig which can be fixed in a stationary position relative to the oral cavity of a patient. The drill jig has a circular-cylindrical recess with a mating guide surface which is intended to cooperate with the guide surface. By means of this cooperation, the drilling direction and the position of the drilled hole are defined by the drill jig. An incorrect orientation and incorrect position of the drilled hole are avoided.

In another embodiment, the drill jig also has a shoulder which projects radially inward relative to the mating guide surface and which is intended to cooperate with the drill abutment surface of the stop element. In this embodiment, a maximum drilling depth is defined by the cooperation between the shoulder and the drill abutment surface.

In another embodiment, the stop element is designed with a sleeve shape, and the engagement element is preferably arranged on a spring element designed as a resilient finger. This embodiment permits a compact structure in the radial direction. This embodiment also makes it possible for the stop element to be fitted from the direction of the receiving end area, since a stop element mounted on the holder portion, with the engagement element engaging in one of the receiving recesses, can be displaced in the direction of the drill end if a certain force is overcome and, in this way, the engagement element can be brought to another of the receiving recesses.

Other configurations of the dental drill device according to the invention are set forth in the following detailed description and claims.

### BRIEF DESCRIPTION OF THE DRAWINGS

FIG. 1 shows a perspective view of a dental drill device according to the invention in a first embodiment, comprising a dental drill with five grooves spaced apart from one another in the axial direction within a holder portion of a cylinder shank, and a stop element designed as a clamp ring and fitted in one of the grooves;

FIG. 2 shows a perspective view of a dental drill device according to the invention in a second embodiment, comprising a dental drill and a stop element, with three thickened areas spaced apart from one another in the axial direction within a holder portion of a cylinder shank, and a stop element mounted on one of the thickened areas;

FIG. 3a shows a perspective view of a dental drill device in a third embodiment, comprising a dental drill and a sleeve-shaped stop element, with three grooves formed in a holder portion of the dental drill, and the stop element being able to be fixed in the axial direction on these grooves;

FIG. 3b shows a side view of the dental drill according to FIG. 3a, with the stop element shown in cross section;

FIG. 4a shows a perspective view of a dental drill device according to the invention in a fourth embodiment, comprising a dental drill fitted into an extension element, and a stop element held on the extension element;

FIG. 4b shows a perspective view of the dental drill device according to FIG. 4a, with the stop element being shown as if transparent;

FIG. 4c shows the dental drill device according to FIG. 4a and FIG. 4b, the dental drill being shown in a side view, and the extension element and the stop element being shown in longitudinal section;

FIG. 4d shows the dental drill device according to FIG. 4a, FIG. 4b and FIG. 4c in a side view; and

FIG. 5 shows a cross sectional view of a dental drill device according to FIG. 2, in which the dental drill is guided in a drill jig.

### DETAILED DESCRIPTION

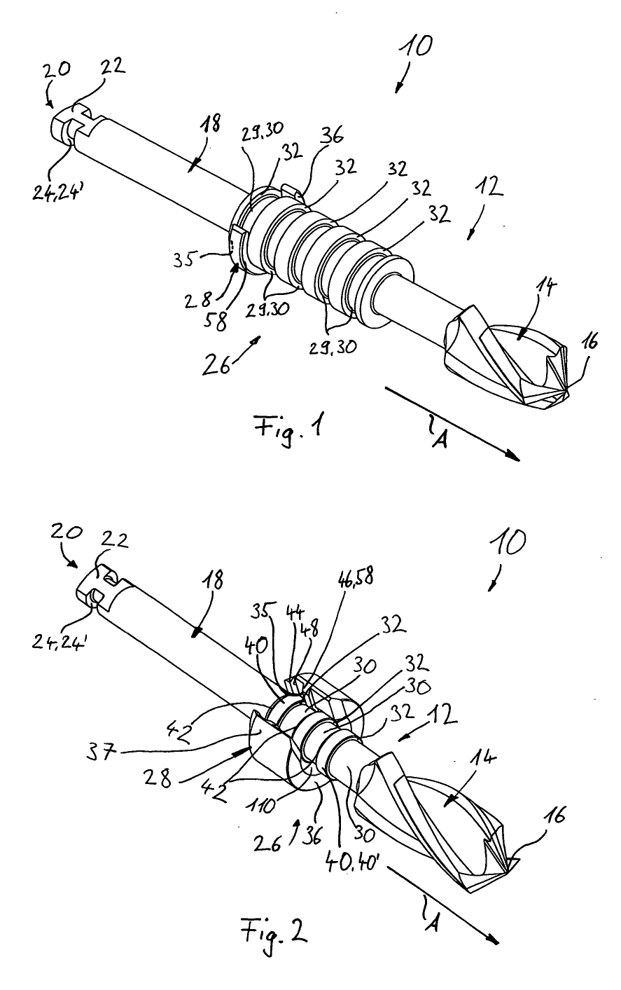

FIG. 1 shows a first illustrative embodiment of a dental drill device 10 according to the invention. A dental drill 12 has, at one end, a cutting part 14 with an exposed drill end 16, and, at the other end, a shank part 18 with an exposed receiving end area 20. The receiving end area 20 is intended to be received in a generally known drill holder device and has a rotation-preventing means 22 configured as a surface, and an axial securing means 24′ designed as a groove 24 extending partially in the circumferential direction. The rotation-preventing means 22 and the axial securing means 24′ means that the dental drill 12 can be brought into a fixed connection with the drill holder device, which for example is part of a drill drive or a hand drill.

The shank part 18 has a holder portion 26 for a stop element 28. This holder portion 26 is formed by a circular-cylindrical thickening of the shank part 18 into which five fastening recesses 30 designed as circumferential grooves 29 are formed. In the axial direction A of the dental drill 12, all the grooves 29 have the same width and, in the radial direction of the dental drill 12, they have the same depth. In the axial direction A, each of the fastening recesses 30 is limited at one end, in the direction of the receiving end area 20 of the shank part 18, by a circular abutment surface 32 at right angles to the axial direction A. Each fastening recess 30 is limited, in the direction of the drill end 16, by another likewise circular limit surface at right angles to the axial direction A.

The stop element 28 of the dental drill device 10 is formed by a circular and open, and therefore C-shaped, clamp ring. The stop element 28 is intended to be inserted into one of the fastening recesses 30, clamping in the radial direction. The stop element 28 forms an engagement element 58.

In the text that follows, the stop element 28 is described as if in the state, shown in FIG. 1, in which it is inserted into one of the fastening recesses 30.

The external diameter of the stop element is chosen to be greater than the external diameter of the holder portion 26 and also greater than the drill diameter of the cutting part 14. The width of the clamp ring, measured in the axial direction A, is chosen at least slightly smaller than the distance of the abutment surface 32 from the opposite limit surface of the fastening recess 30. By means of this configuration, the stop element 28 fitted into one of the fastening recesses 30 protrudes radially past the holder portion 26 and past the cutting part 14. A counter-abutment surface 35 of the stop element 28, facing toward the abutment surface 32, is at right angles to the axial direction A and is intended to cooperate with the abutment surface 32. In the axial direction A, directed away from the counter-abutment surface 35 and toward the drill end 16, the stop element 28 has a drill abutment surface 36 lying at right angles to the axial direction A.

The stop element 28 is preferably designed symmetrically with respect to a plane lying at right angles to the axial direction A, so that the drill abutment surface 36 and the counter-abutment surface 35 are of the same design.

In order to set the drilling depth of a hole that is to be drilled into the jawbone, the stop element 28 is inserted into the relevant recess of the fastening recesses 30. The maximum drilling depth is defined by the distance of the drill abutment surface 36 from the drill end 16. If another maximum drilling depth is desired, the stop element 28 can be removed from the fastening recess 30 and can be inserted into another of the fastening recesses 30.

By means of the abutment surface 32 which lies at right angles to the axial direction A and which cooperates with the counter-abutment surface 35 of the stop element 28, also lying at right angles to the axial direction A, inadvertent changing of the drilling depth is avoided by means of a form fit connection. It is still possible, however, to adapt the maximum drilling depth in a very simple manner—by radial withdrawal of the stop element 28 from one of the fastening recesses 30 and insertion of the stop element 28 into another of the fastening recesses 30.

In further illustrative embodiments and configurations described below, the same reference numbers are used for the same or similar elements.

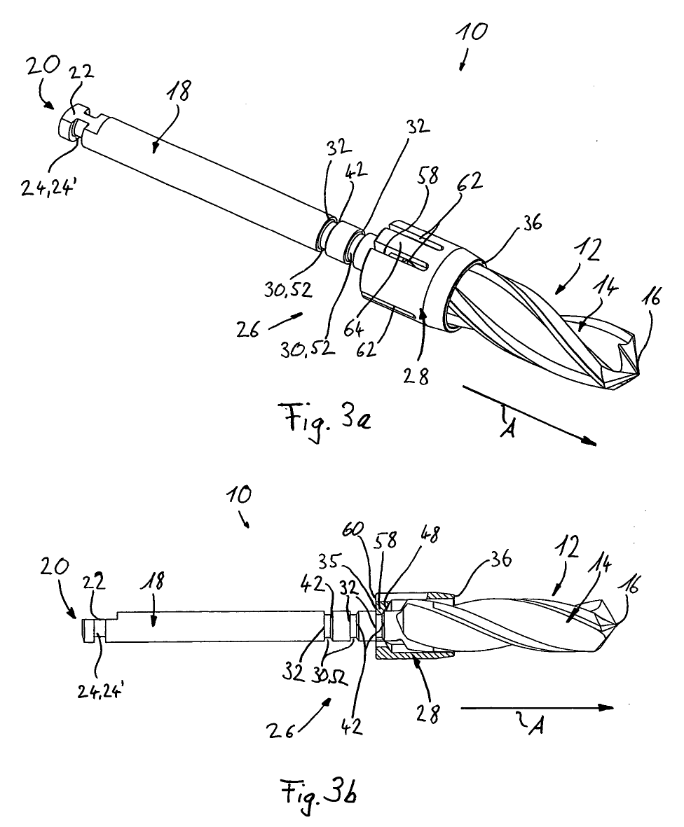

In a second illustrative embodiment of the dental drill device 10 shown in FIG. 2, the dental drill 12 has principally the same design as the dental drill 12 of the first illustrative embodiment, except for the form of the holder portion 26.

In the holder portion 26, the shank part 18 has three circumferential, cuff-like thickened areas 40. The thickened area 40′ lying nearest to the cutting part 14 in the axial direction A is spaced apart from the cutting part 14. Each of the thickened areas 40 has, facing toward the drill end 16, an abutment surface 32 at right angles to the axial direction A of the dental drill 12. Directly adjoining the abutment surface 32 and in the direction of the receiving end area 20, each of the thickened areas 40 initially has a constant diameter. Thereafter, each of the thickened areas 40 narrows to the diameter of the cylinder shank 18. The narrowing is effected via a truncated cone-shaped clamp surface 42.

Fastening recesses 30 are formed between the individual thickened areas 40. A further fastening recess 30 is formed between the cutting part 14 and the thickened area 40′ lying nearest to the cutting part 14. In the direction of the receiving end area 20, each of the fastening recesses 30 is limited by the abutment surface 32.

The stop element 28 has a rectilinear, circular hollow cylinder configuration with a C-shaped cross-sectional surface area, designed principally as an open clamp ring, and is intended to be pushed in the radial direction onto one of the thickened areas 40. An outer jacket surface of the stop element 28 lies on a circular cylinder with a diameter that is greater than a drill diameter of the cutting part 14. One of the end faces of the stop element 28 forms a drill abutment surface 36 and, if the stop element 28 is pushed onto one of the thickened areas 40, lies at right angles to the axial direction A and is exposed in the direction of the drill end 16.

The outer jacket surface of the stop element 28 forms a guide surface 37 intended to cooperate with a mating guide surface 106 of a drill jig 100, which is described further below.

In the text that follows, the stop element 28 is described as if in the state in which it is mounted on one of the thickened areas 40.

The stop element 28 is held on one of the thickened areas 40 in the holder portion 26 of the dental drill 12 by two ridges 44, 46 which are spaced apart from one another in the axial direction A, protrude from an inner jacket surface of the C-shaped cylinder and extend in the circumferential direction. For this purpose, the ridge 44 directed toward the receiving end area has a mating clamp surface 48 that cooperates with the clamp surface 42. The other ridge 46 forms an engagement element 58 and has a counter-abutment surface 35 cooperating with the abutment surface 32. The counter-abutment surface 35, like the abutment surface 32, is at right angles to the axial direction A. The width (in the axial direction A) of the ridges 44, 46 is chosen smaller than the axial spacing of the thickened areas 40 from one another.

The stop element 28 mounted on one of the thickened areas 40 lies with its inner jacket surface on the thickened area 40 lying directly after in the direction of the drill end 16, as a result of which the stop element 28 is supported on this thickened area 40.

If the stop element 28 is mounted on the thickened area 40′ lying nearest to the cutting part 14, the stop element 28 bears on the cutting part 14. For this purpose, the cutting part has a truncated cone jacket surface facing toward the thickened area 40′ and designed to match a support surface 110 on the stop element 28. The support surface 110 narrows, starting from the drill abutment surface 36, to the diameter of the inner jacket surface of the stop element 28.

The handling of the dental drill device 10 according to the second illustrative embodiment is principally the same as the above-described handling of the first illustrative embodiment of the dental drill device. The maximum drilling depth is once again determined by the distance of the drill abutment surface 36 from the drill end 16 of the cutting part 14. The maximum drilling depth can be changed by radial withdrawal of the stop element 28 from the holder portion 26 and by mounting the stop element 28 on the desired thickened area 40. Inadvertent changing of the maximum drilling depth in axial direction A is once again avoided by the form-fit connection between the abutment surface 32 and the counter-abutment surface 35 that cooperates with this abutment surface 32. A secure fit of the stop element 28 in axial direction A is ensured by the cooperation of the clamp surface 42 and the mating clamp surface 48, by which means the counter-abutment surface 35 is pressed firmly onto the abutment surface 32. In the radial direction, the stop element 28 is fixed with a force fit on the dental drill 12 by its being designed as a clamp ring.

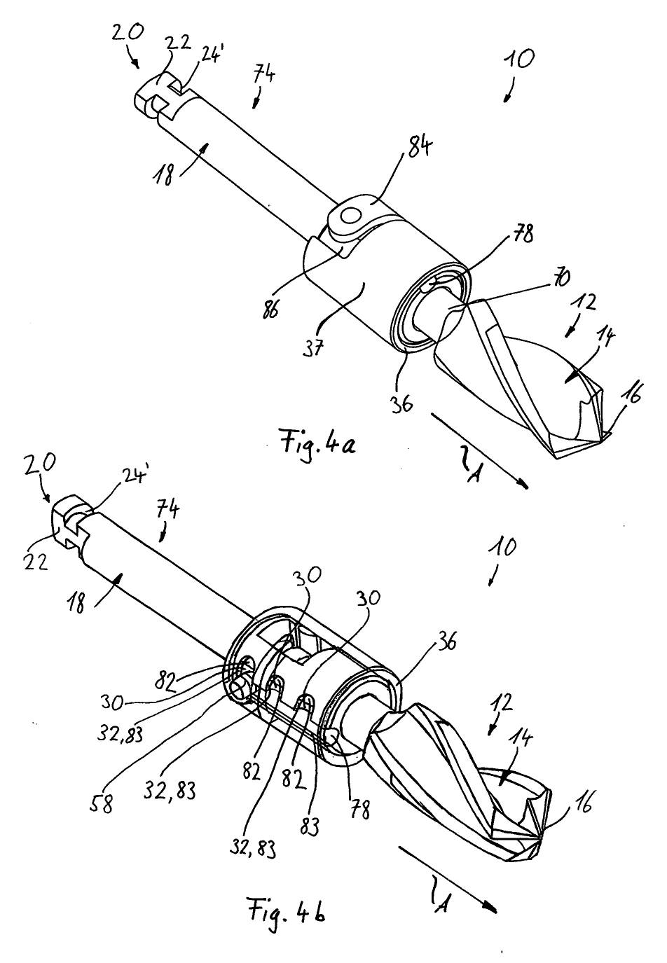

The third illustrative embodiment of the dental drill device according to the invention is shown in FIG. 3a and FIG. 3b.

Except for the form of the holder portion 26, the dental drill 12 is once again principally designed the same as the dental drill 12 of the first illustrative embodiment.

The shank part 18 has a constant diameter and, in the holder portion 26, has three fastening recesses 30 designed as circumferential grooves 52. The holder portion 26 directly adjoins the cutting part 14. Each of the fastening recesses 30 is limited, at one end, by an abutment surface 32 directed toward the receiving end area 20 of the shank part 18 and at right angles to the axial direction A of the dental drill 12, and, at the other end, by a ramp-like clamp surface 42.

Each of the fastening recesses 30 has a circular cylinder surface of constant diameter between the abutment surface 32 and the clamp surface 42. The clamp surface 42 lies on a truncated cone jacket surface, and rises like a ramp from the circular cylinder surface of the fastening recess 30 in the direction of the drill end 16. The diameter of the shank part 18 is chosen smaller than a drill diameter of the cutting part 14.

The stop element 28 has a sleeve-shaped design and is intended to be fitted onto the dental drill 12 from the direction of the receiving end area 20 of the shank part 18. In the text that follows, the stop element 28 is once again described in the state in which it is fitted onto the dental drill 12.

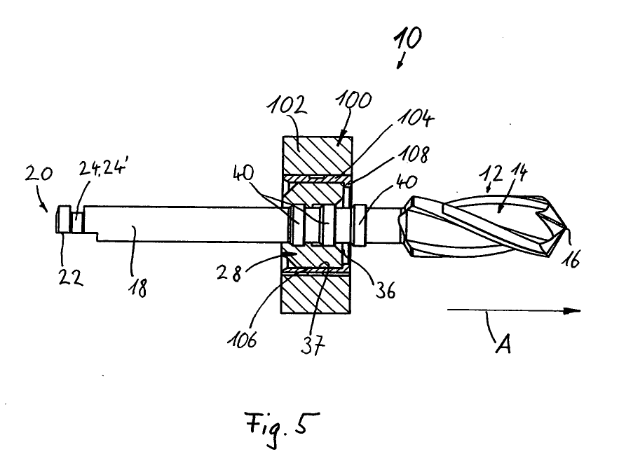

Except in the area of engagement elements 58 that are intended to engage in one of the fastening recesses 30, the internal diameter of the stop element 28 is substantially equal to the drill diameter of the cutting part 14. The stop element 28 has, at one end in the axial direction A, toward the drill end 16, a front drill abutment surface 36 at right angles to the axial direction A and, at the other end, has an end surface 60. An axial end area adjoining the drill abutment surface 36 and belonging to a radially inner jacket surface of the stop element 28 bears on the cutting part 14. An outer jacket surface of the stop element 28 lying on a circular cylinder jacket surface forms a guide surface 37 and can cooperate with the mating guide surface 106 (see FIG. 5) of the drill jig 100. If appropriate, to make it easier to insert the stop element 28 into the drill jig 100, the stop element 28 has, adjacent to the drill abutment surface 36, a jacket surface area formed by a truncated cone surface.

Starting from the end surface 60, the stop element 28 has six recesses 62 which extend in the axial direction A along approximately two thirds of the length of the stop element 28 and open in the direction of the end face surface 60, as a result of which three spring elements 64 designed as resilient arms are formed on the stop element 28. The spring elements 64 are arranged at regular intervals from one another in the circumferential direction. At its free end area, each spring element 64 has an engagement element 58 which is intended to engage in one of the fastening recesses 30. Each engagement element 58 has a counter-abutment surface 35 which is exposed in the direction of the receiving end area 20 and which is intended to cooperate with the abutment surface 32 by which the fastening recess 30 is limited.

A mating clamp surface 48, directed away from the counter-abutment surface 35 on the engagement element 58 in the axial direction A, is intended to cooperate with one of the clamp surfaces 42 of the fastening recesses 30 and, upon engagement of the engagement element 58 in one of the fastening recesses 30, bears on the clamp surface 42 of the respective fastening recess 30. By the cooperation between the mating clamp surfaces 48 and the clamp surface 42, and by the force of the spring elements 64, the counter-abutment surfaces 35 are pressed so as to bear on the abutment surface 32. The counter-abutment surfaces 35 are likewise at right angles to the axial direction A.

The dental drill device 10 according to the third illustrative embodiment is used in the following way.

The stop element 28 is fitted onto the dental drill 12 from the direction of the receiving end area 20, with the drill abutment surface 36 to the front. As soon as the mating clamp surfaces 48 of the engagement elements 58 come to bear on the shank part 18, the spring elements 64 are deflected in the radial direction, as a result of which the counter-abutment surfaces 35 are forced by elastic deflection into a position that is not at right angles to the axial direction A. As soon as the radially inward end edges of the counter-abutment surfaces 35 have passed the abutment surface 32, the spring elements 64 shoot into a parallel orientation to the axial direction A, as a result of which the engagement elements 58 are brought into engagement with the fastening recesses 30, and the counter-abutment surfaces 35 are brought into the position at right angles to the axial direction A. By the spring force of the spring elements 64 and by cooperation between the clamp surface 42 and the mating clamp surfaces 48, the counter-abutment surfaces 35 are pressed into contact against the abutment surface 32. By means of the force fit acting between the abutment surface 32 and the counter-abutment surfaces 35, the stop element 28 is held in one of the fastening recesses 30 and is not displaceable in the direction of the receiving end area 20.

By applying a minimum force oriented in the direction of the drill end 16, the stop element 28 can be displaced in the direction of the drill end 16, so that the engagement elements 58 of the stop element 28 can be brought into the fastening recess 30 lying next in the direction of the drill end 16. By means of the ramp-like clamp surface 42 and the mating clamp surfaces 48, the spring elements 64 are deflected in the radial direction upon a movement of the stop element 28 toward the drill end 16. The engagement elements 58 engage in the next fastening recess 30 in the manner described above. If no further fastening recess 30 is present, the stop element 28 can be drawn off via the cutting part 14. The engagement elements 58 are in this case guided in the chip grooves of the cutting part 14.

If the engagement elements 58 are engaged in one of the fastening recesses 30, the stop element 28 of the third illustrative embodiment too is held on the dental drill 12 by a form-fit connection so as to be non-displaceable in the direction of the free end area 20. In this way, an inadvertent increase in the distance of the drill abutment surface 36 from the drill end 16 is avoided. By contrast, the distance of the drill abutment surface 36 from the drill end 16 can be reduced by displacing the stop element 28 in the direction of the drill end 16.

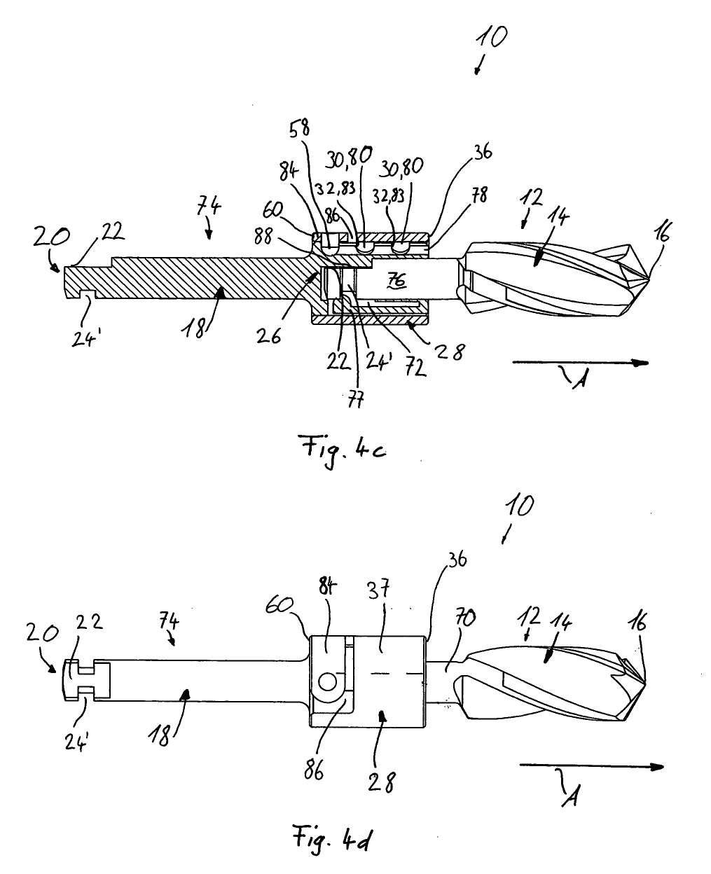

A fourth illustrative embodiment of a dental drill device according to the invention is shown in FIG. 4a, FIG. 4b, FIG. 4c and FIG. 4d.

This dental drill device 10 comprises a dental drill 12 of analogous design to the dental drill of the first illustrative embodiment, the dental drill 12 of the fourth illustrative embodiment having no holder portion. A drill shank 70 is formed integrally on the cutting part 14 of the dental drill 12, and this drill shank 70 again comprises, on an exposed assembly end area 76, an axial securing means 24′ and a means 22 for preventing rotation, analogously to the dental drill of the first illustrative embodiment. The drill shank 70 is shorter than the shank part of the dental drill of the first illustrative embodiment. The assembly end area 76 is intended to be received in a corresponding receiving recess 72 of an extension element 74.

The extension element 74 comprises a shank part 18 with one radial step. The area of the stepped shank part 18 that has a greater diameter forms a holder portion 26. Within the holder portion 26, the shank part 18 is provided with the receiving recess 72. Lying at the opposite end from the receiving recess 72, the shank part 18 has a receiving end area 20. The receiving end area 20 is intended to be received in a drill holder device. For this purpose, the receiving end area 20 has an axial securing means 24′ and a means 22 preventing rotation, which are designed analogously to the axial securing means 22 and the means 24′ preventing rotation of the dental drill 12. A sleeve-shaped stop element 28 can be fitted onto the holder portion 26.

In the text below, the dental drill device 10 is described in a state in which the assembly end area 76 of the dental drill 12 is held in the receiving recess 72 by a spring element, preferably a spring arm 77, that engages in the axial securing means 24′. Moreover, the stop element 28 is pushed onto the holder portion 26 from the direction of the drill end 16.

The holder portion 26 principally has a radially outer, circular-cylindrical jacket surface which serves as a guide surface for a sleeve-shaped stop element 28. The external diameter of the holder portion 26 is chosen slightly greater than the drill diameter of the dental drill 12. A channel-like structure formed by grooves is let into the holder portion 26. A guide groove 78 extends in the axial direction A of the dental drill 12 and is open in the direction of the drill end 16. Three fastening recesses 30 designed as circumferential grooves 80 run in the circumferential direction from the guide groove 78, all of them in the same direction.

The circumferential grooves 80 all have the same length and have a locking recess 82 at their end areas remote from the guide groove 78 in the circumferential direction. The cross sections of the guide grooves 78 (in the circumferential direction) and those of the circumferential grooves 80 (in the axial direction) are substantially the same and, adjacent to the jacket surface, have side walls 83 extending parallel to the radial direction. A groove base of the guide groove 78 and also of the circumferential grooves 80 is of a cylindrical design. The locking recesses 82 are made deeper in the radial direction than the remaining area of the fastening recesses 30, the side walls 83 being continued in the radial direction and the groove base thus being lowered farther in the area of the fastening recess 30.

Each fastening recess 30 has an abutment surface 32 which is at least approximately at right angles to the axial direction A and is formed by a portion of the side wall 83 that limits the fastening recess in the direction of the receiving end area 20.

The stop element 28 that can be fitted onto the holder area 26 has a sleeve-shaped design. In the axial direction A, the stop element 28 has, at one end toward the drill end 16, a front drill abutment surface 36 lying at right angles to the axial direction A, and, at the other end, it has an end face 60. An outer jacket surface of the stop element 28 lying on a circular-cylindrical jacket surface forms a guide surface 37.

When using a drill jig 100, described in more detail in connection with FIG. 5, the guide surface 37 cooperates with a mating guide surface 106 of the drill jig 100.

A spring element 84 arranged in the circumferential direction and designed as a resilient finger is formed by a slit-like recess 86 on the stop element 28. The recess 86 starts from the end face 60 and extends first in the axial direction A and then in the circumferential direction.

Secured at the free end area of the spring element 84 there is a pin-like engagement element 58 which protrudes radially inward and which is intended to engage in the grooves 78, 80. Directly adjacent to a radially inward surface of the spring element 84, the engagement element 58 has a circular-cylindrical portion and, adjoining the latter in the radial direction, a hemispherical portion which is intended to cooperate with one of the locking recesses 82. The circular-cylindrical portion forms a counter-abutment surface 35 which is intended to cooperate with one of the abutment surfaces 32. The diameter of the hemispherical portion and of the cylindrical portion is chosen such that the engagement element 58 in the fastening recess 30 has little play in the axial direction A.

The dental drill device 10 according to the fourth illustrative embodiment is used in the following way.

The dental drill 12 is inserted, with the assembly area 76 leading, into the receiving recess 72 of the extension element 74, as a result of which the spring arm 77 comes into engagement into the axial securing means 24′ of the dental drill 12.

With the end face 60 leading, the stop element 28 is fitted onto the dental drill 12 from the direction of the drill end 16 and is moved in the axial direction A toward the holder portion 26. When fitting the stop element onto the holder portion 26, care must be taken to ensure that the engagement element 58 is aligned with the guide groove 78. When the stop element 28 is moved farther, the engagement element 58 is guided in the guide groove 78.

A radial deflection of the spring arm 77 is made impossible by the stop element 28 being pushed on, as a result of which the dental drill 12 is secured in the receiving recess 72 of the extension element 74.

Once the engagement element 58 has been brought into alignment with the desired fastening recess 30 by displacement of the stop element 28 in the axial direction A, the stop element can be turned in the circumferential direction, as a result of which the engagement element 58 engages in the locking recess 82 of the fastening recess 30.

When the engagement element 58 engages in one of the fastening recesses 30, the stop element 28 is secured in the axial direction A, in particular in the direction of the receiving end area 20 of the cylinder shank 18, by a form fit connection between the abutment surface 32 and the counter-abutment surface 35. When the engagement element 58 engages in one of the locking recesses 83, the stop element 28 is held secure against turning in the circumferential direction by means of a force fit.

The desired maximum drilling depth of the dental drill device 10 according to the fourth illustrative embodiment is once again defined by the distance of the drill abutment surface 36 from the drill end 16.

The maximum drilling depth can once again be modified in a very simple manner. To do so, the stop element 28 is first turned in the circumferential direction and in the direction of the guide groove 78 so that, by overcoming the force-fit connection, the engagement element 58 is moved out of the locking recess 82 in which said engagement element 58 engages. The stop element 28 is then moved in the axial direction A, the engagement element 58 is aligned with another fastening recess 30 and, by turning the stop element 28, the engagement element 58 comes into engagement in the fastening recess 30.

It is likewise possible for the stop element 28 to be pre-fitted on the extension element 74 in the holder portion 26. In this case, the spring arm 77 has such great freedom of movement relative to the stop element 28 that, when the assembly area 76 of the dental drill 12 is inserted into the receiving opening 72, the spring arm 77 is able to deflect in order to lock in the axial securing means 24′.

In the illustrative embodiments described above, the desired drilling depth is defined by the distance of the drill abutment surface 36 from the drill end 16.

When the desired drilling depth is reached upon drilling a hole in a jawbone, the abutment surface comes to rest on the jawbone or on the gum surrounding the jawbone.

FIG. 5 shows a further configuration of the dental drill device according to the second illustrative embodiment. This configuration comprises a drill jig 100 which guides the dental drill 12 with the stop element 28 arranged thereon.

The drill jig 100 is intended to be secured in a fixed position relative to the oral cavity of a patient. The drill jig 100 is preferably produced from an impression of the upper jaw or lower jaw. The drill jig 100 has a drill jig plate 102 with a fixed drill jig sleeve 104 positioned therein. A radially inward surface of the drill jig sleeve 104 forms a mating guide surface 106 for the guide surface 37 of the stop element 28. At an axial end area, the drill jig sleeve 104 has an annular shoulder 108 that projects radially inward. The shoulder 108 forms a counter-abutment for the drill abutment surface 36 of the stop element 28.

The dental drill device 10 shown in FIG. 5 is used in the following way.

For treating a patient, the drill jig 100 is arranged in the patient's oral cavity, or in direct proximity to it, and fixed in position relative to the oral cavity. The shoulder 108 of the drill jig 100 is directed toward the hole that is to be drilled, that is to say toward the jawbone. The desired drilling depth is defined by means of the stop element 28 on the dental drill 12, by fitting the stop element onto one of the thickened areas 40. In this illustrative embodiment, the desired maximum drilling depth is determined by the distance of the drill abutment surface 36 from the shoulder 108. The position and direction of the drilled hole are defined by the insertion of the stop element into the recess formed by the drill sleeve 104 in the drill jig, and by the cooperation between the guide surface 37 of the stop element 28 and the counter-abutment surface 106.

Consequently, by means of the dental drill device 10 according to FIG. 5, it is possible, in a very simple way, to drill a hole at the desired position, in the desired direction and to the desired depth. An obstructed view during the drilling operation, caused by material from the drilled hole, has no effect on the precision of the hole that is to be drilled.

It is likewise possible to do without the shoulder 108 on the drill jig 100. Consequently, the maximum drilling depth is again set by the distance of the drill abutment surface 36 from the drill end 16. When the maximum drilling depth is reached, the drill abutment surface 36 rests on the jawbone or gum.

Of course, the use of the drill jig 100 is not limited to the dental drill according to the second illustrative embodiment. A dental drill according to the third illustrative embodiment, or a dental drill in combination with an extension element according to the fourth illustrative embodiment, can likewise be used with the drill jig.

If a hole is drilled without using the drill jig, the radial guide surface 37 of the third and fourth illustrative embodiments can still make guiding easier during drilling, by means of the guide surface 37 being rested laterally on an element.

The number of fastening recesses in all the illustrative embodiments can of course be varied almost in any desired extent and is not limited to the numbers cited in the illustrative embodiments.

Likewise, the first three illustrative embodiments, which do not have an extension element, can in fact be realized with an extension element, analogously to the fourth illustrative embodiment. The holder portion is then not arranged on the dental drill, but instead on the extension element. Consequently, the stop element is held not on the dental drill, but instead on the extension element.

The fourth illustrative embodiment can likewise be realized without an extension element. The holder portion is then arranged on the shank part of the dental drill, analogously to the dental drills of the first to third illustrative embodiments. The stop element is consequently held on the dental drill. The necessary adjustments are once again evident to a person skilled in the art.

1. A dental drill device comprising a drill having a stop element arranged thereon, the drill having, at one end, a cutting part with a front drill end and, at the other end, a shank part with a receiving end area which is intended to be received in a drill-holder device, the shank part having a holder portion for the stop element, and the stop element having a drill abutment surface which is exposed in the direction of the drill end and which is held on the drill at a desired distance from the drill end, wherein several fastening recesses spaced apart from one another in the axial direction (A) of the drill are arranged within the holder portion of the drill, and the stop element has an engagement element engagable in one of the fastening recesses, wherein the fastening recesses, on their side directed toward the receiving end area, are limited by an abutment surface extending at least approximately at right angles to the axial direction (A), and the engagement element has a counter-abutment surface which cooperates in a form fit with the relevant abutment surface.

2. The dental drill device as claimed in claim 1, wherein the stop element has a radially outward, circular-cylindrical guide surface.

3. The dental drill device as claimed in claim 2, including a drill jig which can be fixed in a stationary position relative to the oral cavity of a patient and having a recess with a circular-cylindrical mating guide surface which cooperates with the guide surface of the stop element.

4. The dental drill device as claimed in claim 4, wherein the drill jig has, in relation to the mating guide surface, a radially inwardly projecting shoulder which cooperates with the drill abutment surface of the stop element.

5. The dental drill device as claimed in claim 1, wherein to each of the abutment surfaces is assigned a truncated-cone-shaped clamp surface which cooperates with the stop element to keep the counter-abutment surface bearing on the abutment surface.

6. The dental drill device as claimed in claim 5, wherein the clamp surface cooperates with the engagement element.

7. The dental drill device as claimed in claim 1, wherein each fastening recess has a locking recess, and the engagement element engages with a force fit in the relevant locking recess to fix the stop element in the circumferential direction.

8. The dental drill device as claimed in claim 1, wherein the stop element has a sleeve-shaped design.

9. The dental drill device as claimed in claim 8, wherein the engagement element is arranged on a spring element comprising a resilient finger.

10. The dental drill device as claimed in claim 1, wherein the stop element has a radially inward jacket surface.

11. The dental drill device as claimed in claim 10, wherein the jacket surface adjoins the drill abutment surface and bears on the cutting part.

12. A dental drill device with a drill defining an axial direction (A), with an extension element, and with a stop element arranged on the latter, the drill having, at one end, a cutting part with a front drill end and being intended, at the other end, to be held on the extension element, the extension element having a receiving end area receivable in a drill holder device, and a holder portion for the stop element, and the stop element having a drill abutment surface which is exposed in the direction of the drill end and which is held on the extension element at a desired distance from the drill end, wherein several fastening recesses spaced apart from one another in the axial direction (A) of the extension element are arranged thereon within the holder portion, and the stop element has an engagement element engagable in one of the fastening recesses, said fastening recesses being limited, on their side directed toward the receiving end area, by an abutment surface extending at least approximately at right angles to the axial direction (A), and the engagement element having a counter-abutment surface which cooperates in a form fit with the relevant abutment surface.

13. The dental drill device as claimed in claim 12, wherein the stop element has a radially outward, circular-cylindrical guide surface.

14. The dental drill device as claimed in claim 13, including a drill jig which can be fixed in a stationary position relative to the oral cavity of a patient and having a recess with a circular-cylindrical mating guide surface which cooperates with the guide surface of the stop element.

15. The dental drill device as claimed in claim 14, wherein the drill jig has, in relation to the mating guide surface, a radially inwardly projecting shoulder which cooperates with the drill abutment surface of the stop element.

16. The dental drill device as claimed in claim 12, wherein to each of the abutment surfaces is assigned a truncated-cone-shaped clamp surface which cooperates with the stop element to keep the counter-abutment surface bearing on the abutment surface.

17. The dental drill device as claimed in claim 16, wherein the clamp surface cooperates with the engagement element.

18. The dental drill device as claimed in claim 12, wherein each fastening recess has a locking recess, and the engagement element engages with a force fit in the relevant locking recess to fix the stop element in the circumferential direction.

19. The dental drill device as claimed in claim 12, wherein the stop element has a sleeve-shaped design.

20. The dental drill device as claimed in claim 19, wherein the engagement element is arranged on a spring element comprising a resilient finger.

21. The dental drill device as claimed in claim 12, wherein the stop element has a radially inward jacket surface.

22. The dental drill device as claimed in claim 21, wherein the jacket surface adjoins the drill abutment surface and bears on the cutting part.
